(19) United States
(12) Patent Application Publication
(10) Pub. No.: US 2007/0002027 A1
(43) Pub. Date: Jan. 4, 2007

(54) Smart control method for cursor movement using a touchpad

(76) Inventors: Jia-Yih Lii, Taichung City (TW); Kuan-Chun Tang, Toufen Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/274,177

(22) Filed: Nov. 16, 2005

(30) Foreign Application Priority Data
Jun. 29, 2005 (TW) 094121990

(51) Int. Cl. G09G 5/00

(52) U.S. Cl. 345/173

(57) ABSTRACT

A smart control method for cursor movement using a touchpad comprises detecting the location of an object touched on the touchpad for determining the coordinate information of the object, detecting the movement of the object on the touchpad for generating the location information of the object, and generating a signal representative of moving a cursor if the object is detected to stop moving on and stay on the touchpad for a period longer than a threshold time.

### FIELD OF THE INVENTION

The present invention is generally related to a touchpad and, more particularly, to a smart control method for cursor movement using a touchpad.

### BACKGROUND OF THE INVENTION

Touchpad has been widely used in various electronic products, including notebook computer, personal digital assistant (PDA), mobile phone and other electronic systems. Touchpad serves as an input device where users touch or slide on the operational zone of the touchpad by objects such as finger and pen, to control a cursor on a window in relative movement or absolute coordinate movement and to support other extended functions such as simulated buttons. For more versatile functions on the operational zone, partitioning of the operational zone is employed, together with detection methods to determine which function is desired for use.

Along with the progress in monitor and display card technologies, computers nowadays are usually able to support high resolution screens, for example 1024×768. However, touchpad is limited by its size and therefore does not support such high resolution actually. To overcome this drawback, a smart edge function is proposed for touchpad, by which the cursor can move automatically when the user slides his finger to the pre-defined edge zone of the touchpad. As shown in FIG. 1, touchpad 10 is defined to have two zones 12 and 14, and the zone 14 occupies the edge of the touchpad 10 and is divided into eight blocks corresponding to move cursor 18 upward, downward, leftward, rightward, left-upward, left-downward, right-upward, and right-downward, respectively. When user's finger 16 moves within the zone 12, the touchpad 10 will send out the location information of the finger 16 to control the cursor 18 on a window in response to the movement of the finger 16. While the finger 16 moves into the zone 14, the touchpad 10 will send out a scrolling signal to control the cursor 18 to automatically move along the direction depending on which block of the zone 14 the finger 16 moved into. In regard to the smart edge function, readers may refer to U.S. Pat. No. 5,543,590 to Gillespie et al. for more detail operations.

However, such smart edge function is only able to send out scrolling signal with the cursor's moving direction once user's finger slides to the edge zone 14, but not able to judge if the user intends to operate with general cursor movement or smart automatic scrolling. Therefore, wrong operations may occur frequently. For example, the user might intend to move the cursor 18 as the trace shown in FIG. 2, but unintentionally slides his finger 16 into the edge zone 14 during the movement, causing the touchpad 10 to send out a scrolling signal, and the cursor 18 will move along the trace as shown in FIG. 3 instead. Moreover, as a result of dividing the zone 14 into eight blocks, the automatic movement of the cursor 18 is restricted to eight specific and pre-defined directions, which fails to satisfy and accommodate the demands of the user for moving the cursor 18 in unlimited directions.

In addition, the volume of electronic product is scaled down more and more, leading the size of touchpad to be reduced accordingly. Once a touchpad is divided into several regions, it will be inconvenient for users to operate thereon.

Therefore, it is desired a smart control method for cursor movement using a touchpad that does not require to pre-define specific zones on the touchpad to activate the movement control of the cursor and does not restrict the movement direction of the cursor.

### SUMMARY OF THE INVENTION

An object of the present invention is to propose a smart control method for cursor movement using a touchpad, by which the touchpad needs not to be pre-defined with specific zones for activating the movement control of the cursor and the movement direction of the cursor is free.

In a smart control method for cursor movement using a touchpad, according to the present invention, the location of an object touched on the touchpad is detected for determining the coordinate information of the object, whenever the object moves on the touchpad, a signal representative of the location information of the object is generated for movement control of a cursor based on the movement of the object, and if the object stops moving on and stays on the touchpad for a period longer than a threshold time, a signal representative of moving the cursor is generated.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a normal operation of a finger on a touchpad;

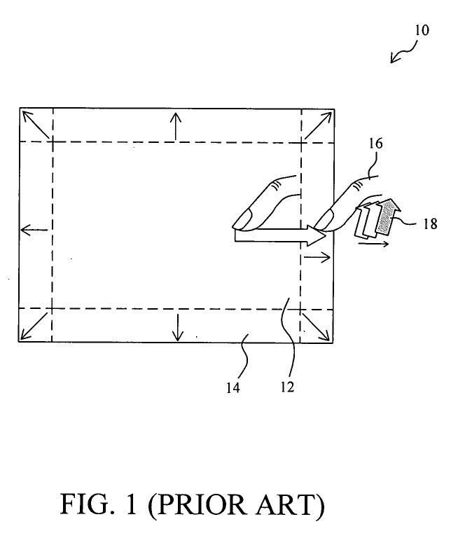

FIG. 2 shows an unintentional operation of a finger on a touchpad;

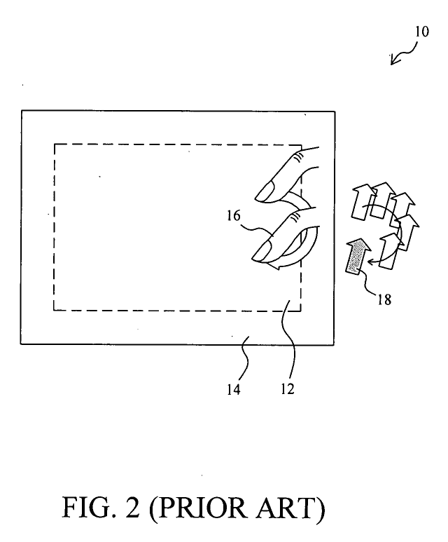

FIG. 3 shows a wrong detection of an operation of a finger on a touchpad;

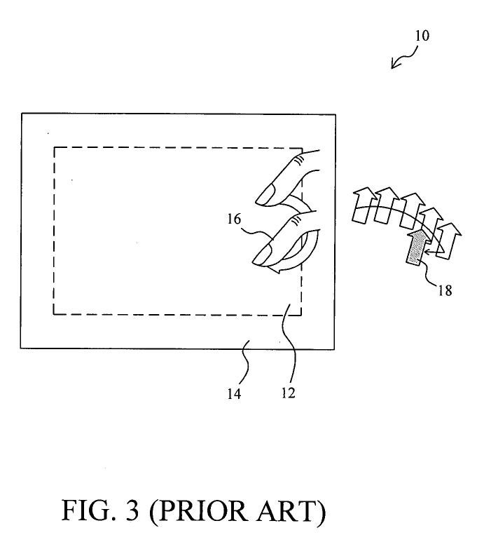

FIG. 4 shows a flowchart in one embodiment according to the present invention; and

FIG. 5 shows an operation of a finger on a touchpad according to the present invention.

### DETAILED DESCRIPTION OF THE INVENTION

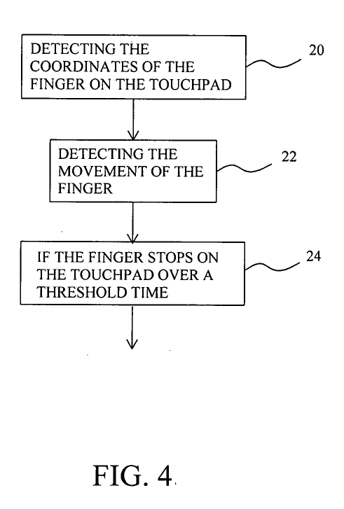

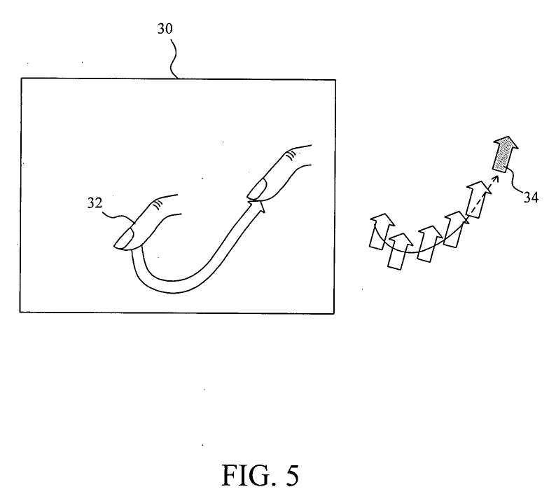

FIG. 4 shows a flowchart in one embodiment according to the present invention and FIG. 5 shows an operation of a finger on a touchpad according to the present invention. Referring to FIGS. 4 and 5, in step 20 the location of a finger 32 touched on a touchpad 30 is detected for determining the coordinates of the finger 32, in step 22 the movement of the finger 32 on the touchpad 30 is detected for generating a signal representative of the location information of the finger 32 for a cursor 34 to move in response to the movement of the finger 32, and in step 24 if the finger 32 is detected to stop moving on and stay on the touchpad 30 for a period longer than a threshold time, a signal is generated for moving the cursor 34 automatically along the direction it was moving on before it stops moving. Typically, the touchpad 30 includes a sensor having two directional traces for sensing where the finger 32 is touching on. The coordinates of the finger 32 touched on the touchpad 30 may be either absolute or relative coordinates, and the location information of the finger 32 generated by the touchpad 30 may include either an absolute or relative movement amount. The absolute coordinates are defined as the coordinate values in a coordinate system based on a fixed position, e.g. the center or one of the corners, of the touchpad 30 as the original point. The relative coordinates are referred to the coordinate values determined by the current position of the finger 32 apart from a relative position., e.g. that the finger 32 first touches or lands on the touchpad 30. The absolute movement amount is that calculated from the fixed position, while the relative movement amount is referred to that calculated from the relative position.

In a method of the present invention, there is no need to pre-define specific zones on the touchpad 30 for the function of starting up a smart movement control of a cursor, which allows for a greater region on the touchpad for the finger 32 to operate. For the smart movement control of a cursor, it is the direction that the finger 32 was moving on before it stops moving on the touchpad 32 to determine the cursor 34 to automatically move on, so that it introduces no restriction on the movement direction of the cursor 34 to automatically move on, resulting in more convenient operations for users.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A smart control method for cursor movement using a touchpad, comprising the steps of:
detecting an object touched on the touchpad for determining a coordinate information of the object;
detecting a movement of the object on the touchpad for generating a first signal including a location information of the object; and
generating a second signal representative of moving a cursor if the object is detected to stop moving on and stay on the touchpad for a period longer than a threshold time.

2. The method of claim 1, wherein the second signal comprises a direction information determined by that the object was moving on before it stops moving.

3. The method of claim 1, wherein the coordinate information comprise absolute or relative coordinates.

4. The method of claim 1, wherein the location information comprises an absolute or relative movement amount.
